(19) United States
(12) Patent Application Publication
(10) Pub. No.: US 2020/0361128 A1
(43) Pub. Date: Nov. 19, 2020

(54) INJECTION MOLDING METHOD AND INJECTION MOLDING DEVICE

(71) Applicant: HONDA MOTOR CO., LTD., Minato-ku, Tokyo (JP)

(72) Inventors: Tomoki Maeda, Haga-gun, Tochigi-ken (JP); Masahiro Yasuda, Haga-gun, Tochigi-ken (JP); Takuma Koshiji, Haga-gun, Tochigi-ken (JP); Shun Hosoi, Haga-gun, Tochigi-ken (JP); Shinichi Nobuhara, Haga-gun, Tochigi-ken (JP)

(21) Appl. No.: 16/967,150

(22) PCT Filed: Feb. 8, 2019
(86) PCT No.: PCT/JP2019/004540

§ 371 Date: Aug. 4, 2020

(30) Foreign Application Priority Data
Feb. 9, 2018 (JP) 2018-022160

(51) Int. Cl. B29C 45/28; B29C 45/22

(52) U.S. Cl. CPC B29C 45/2806; B29L 2031/3044; B29C 45/22

(57) ABSTRACT

An injector includes a nozzle provided with a valve seat, a valve body which is seated on or separated from the valve seat, and a displacement means for displacing the valve body. A resin flow passage through which molten resin flows is formed inside the nozzle. The resin flow passage includes a cross-sectional area varying portion having a cross-sectional area, in a direction orthogonal to a flow direction, which varies with increasing distance toward or away from the valve body. The displacement means is capable of stopping the valve body in any position in the cross-sectional area varying portion.

### TECHNICAL FIELD

The present invention relates to an injection molding method and an injection molding device for obtaining a molded article by filling a cavity with molten resin.

### BACKGROUND ART

A resin molded article has become widely adopted as an exterior component or interior component of an automobile vehicle body. This kind of resin molded article is manufactured by filling, with molten resin, a cavity formed in an injection molding device, and then cooling and solidifying the molten resin. Since an exterior component or interior component of an automobile vehicle body is generally large-sized, the cavity too is considerably large-sized.

In the case of such a large-sized cavity, molten resin is injected into the cavity from a plurality of injectors, as described in Japanese Laid-Open Patent Publication No. 2015-178273. Now, Japanese Laid-Open Patent Publication No. 2015-178273 discloses an injection molding method in which the cavity is filled with molten resin being injected from all of injection machines (the injectors), and, furthermore, so-called pressure keeping is performed, after which an additional step, in which a valve pin of each of the injectors is set to an intermediate position between a fully open position and a fully closed position, is performed. According to description of Japanese Laid-Open Patent Publication No. 2015-178273, performing such an additional step makes it possible for pressure of molten resin within the cavity to be made substantially uniform, and enables a molded article in which hollows, and so on, have been reduced, to be obtained.

Moreover, Japanese Utility Model Registration No. 3202772 discloses an injector in which it is possible for the valve pin to be stopped at an intermediate position between the fully open position and the fully closed position. In this conventional technology, it is being attempted that an injection amount of molten resin is controlled by setting a stopping position of the valve pin to any intermediate position.

When obtaining a large-sized molded article, in the case where injection is performed by using dedicated molding molds in which a cavity of large volume can be formed, and employing an existing operating pressure supply facility or the like, with injection conditions set substantially similarly, it is expected that pressure of resin filling the cavity exceeds an operating pressure, and the molding molds separate from each other (so-called mold-floating occurs). When such a situation occurs, a burr ends up occurring.

In order to avoid this, reducing a supply pressure of the molten resin comes to mind. However, in this case, there is concern that a hollow (also called a “deformation”) is generated in the molded article.

Moreover, in the case where the molten resin is injected from a plurality of injectors into the cavity of large volume, a difference may occur in timings at which the molten resin reaches each of extremities of the cavity, and solidification may occur before the extremities are reached, depending on injection speed or injection pressure of the individual injectors. Accordingly, it comes to mind to adjust the injection speed or injection pressure by setting a position of the valve pin in the injector to an intermediate position as described in Japanese Utility Model Registration No. 3202772 and making the intermediate position different among the injectors.

However, a clearance (a “ring-shaped passage” referred to in Japanese Utility Model Registration No. 3202772) formed between the valve pin and a resin flow passage is extremely narrow. Hence, even when the valve pin is displaced only slightly, the injection speed varies sensitively. Therefore, injection amount or injection pressure, and furthermore, a pressure imparted on the molten resin within the cavity during pressure keeping, are difficult to adjust.

A main object of the present invention is to provide an injection molding method by which it is possible to obtain a resin molded article which excels in aesthetic appearance, and, moreover, in which burrs or hollows are suppressed.

Another object of the present invention is to provide an injection molding device in which it is easy for an imparted pressure during pressure keeping to be adjusted according to a region of a resin molded article.

According to an embodiment of the present invention, there is provided an injection molding method for obtaining a molded article by injecting molten resin into a cavity of an injection molding device from a plurality of injectors, the injection molding method including:

a filling step in which a valve body provided within each of the injectors and configured to open or close an injection port of the injector is separated from a valve seat to set the injection port to an open state, and the cavity is filled with molten resin; and

a pressure keeping step in which the valve body is moved to a predetermined intermediate position between a fully closed position and a fully open position, and the molten resin within the cavity is pressurized,

the predetermined intermediate position being made different in at least two of the injectors.

In the injectors whose predetermined intermediate positions of the valve body differ, injection speeds or injection pressures of molten resin from the nozzle differ. That is, by making the predetermined intermediate positions different, the injection speed or injection pressure of molten resin can be set to a desired degree for each of injections. In other words, it is possible for resin pressure within the cavity to be adjusted at will.

As a result, there can be performed pressure keeping in which resin pressures are made different according to region; for example, in the resin molded article, resin pressure is made large in a region where a contraction amount of the resin during solidification is large in order for a boss, rib or the like to be provided, and resin pressure is made small in another region where the contraction amount is small. Hence, it is avoided that a burr is formed by mold-floating occurring due to overall resin pressure having become excessively large, or that a hollow is formed due to overall resin pressure having become excessively small, so a resin molded article excelling in aesthetic appearance can be obtained.

A configuration may be adopted such that resin pressure is adjusted as above not only in the pressure keeping step, but also in the filling step. That is, in the filling step, the valve body is set to a predetermined intermediate position between the fully closed position and the fully open position, and the predetermined intermediate position is made different in at least two of the injectors, whereby injection speed or injection pressure of molten resin into the cavity is made different.

In this case, timings from start to completion of injection (filling) of molten resin from the injections can be matched. Therefore, a cooling speed of the molten resin becomes substantially equal over the entire inside of the cavity. This too contributes to an improvement in aesthetic appearance of the resin molded article.

Now, preferably, a cross-sectional area varying section whose cross-sectional area in a direction orthogonal to a flow direction varies with decreasing or increasing distance from the valve body, is provided in a resin flow passage along which the molten resin flows in the nozzle, and the predetermined intermediate position is set within a range of the cross-sectional area varying section.

In this nozzle, resin pressure varies gently when the valve body is displaced within a range of the cross-sectional area varying section. That is, by providing the cross-sectional area varying section, and setting the position of the valve body within the range of the cross-sectional area varying section, resin pressure can be easily varied to a desired degree. In other words, it becomes easy to adjust the resin pressure to any resin pressure. It thus becomes easy for injection speed or injection pressure of the molten resin to be set to a desired degree for each injection.

Moreover, according to another embodiment of the present invention, there is provided an injection molding device that obtains a molded article by injecting molten resin into a cavity from a plurality of injectors,

the injector including: a nozzle provided with a valve seat; a valve body that is seated on or separated from the valve seat; and a displacement unit configured to displace the valve body in a direction of approaching or separating from the valve seat,

a resin flow passage along which the molten resin flows being formed inside the nozzle,

the resin flow passage including a cross-sectional area varying section whose cross-sectional area in a direction orthogonal to a flow direction varies with decreasing or increasing distance from the valve body, and

the displacement unit being configured to stop the valve body at any position in the cross-sectional area varying section.

By the resin flow passage within the nozzle being configured to include the cross-sectional area varying section, it becomes easy for the injection speed or injection pressure of the molten resin to be set to a desired degree for each injection as mentioned above. Therefore, a molded article which excels in aesthetic appearance and in which formation of burrs or hollows is suppressed can be easily obtained.

The cross-sectional area varying section may be one whose cross-sectional area becomes larger with decreasing distance to the valve seat, for example. Note that, contrarily, the cross-sectional area varying section may be one whose cross-sectional area becomes smaller with decreasing distance to the valve seat.

According to the present invention, a configuration is adopted such that, by setting the valve body to the predetermined intermediate position (between the fully closed position and the fully open position) of the resin flow passage along which the molten resin flows in the nozzle, resin pressure is adjusted to a desired degree. Moreover, by the predetermined intermediate positions being made different in at least two injections, the resin pressures are made different.

Hence, in the present invention, there can be performed pressure keeping in which resin pressures are made different according to region; for example, in the resin molded article, resin pressure is made large in a region where a contraction amount of the resin during solidification is large in order for a boss, rib or the like to be provided, and resin pressure is made small in another region where the contraction amount is small. It is thus avoided that resin pressure becomes excessively large overall, or, conversely, becomes excessively small overall. As a result, it is suppressed that burrs or hollows are formed in the resin molded article, so a resin molded article excelling in aesthetic appearance is obtained.

### BRIEF DESCRIPTION OF DRAWINGS

FIG. 1 is a principal parts outline perspective schematic view schematically showing principal parts of an injection molding device according to an embodiment of the present invention, and a front bumper (a resin molded article) obtained by the injection molding device;

FIG. 2 is a principal parts outline cross-sectional view of a first injector shown in FIG. 1;

FIG. 3 is an overall outline cross-sectional view of a top nozzle configuring the first injector shown in FIG. 2;

FIG. 4 is a principal parts cross-sectional view showing that a valve pin is displaceable within a range of a cross-sectional area varying section formed in the top nozzle;

FIG. 5 is a time chart showing degrees of opening of the valve pins of the first through fourth injectors shown in FIG. 1, and timings of opening adjustment thereof;

FIG. 6 is a graph showing change in resin pressure in the top nozzle provided with the cross-sectional area varying section, and change in resin pressure in a top nozzle not provided with the cross-sectional area varying section (a top nozzle whose inner diameter or cross-sectional area is constant); and

FIG. 7 is an overall outline cross-sectional view of a top nozzle provided with a cross-sectional area varying section of another shape.

### DESCRIPTION OF EMBODIMENTS

A preferred embodiment of an injection molding method according to the present invention will be presented and described in detail below with reference to the accompanying drawings, in relation to an injection molding device for implementing the injection molding method.

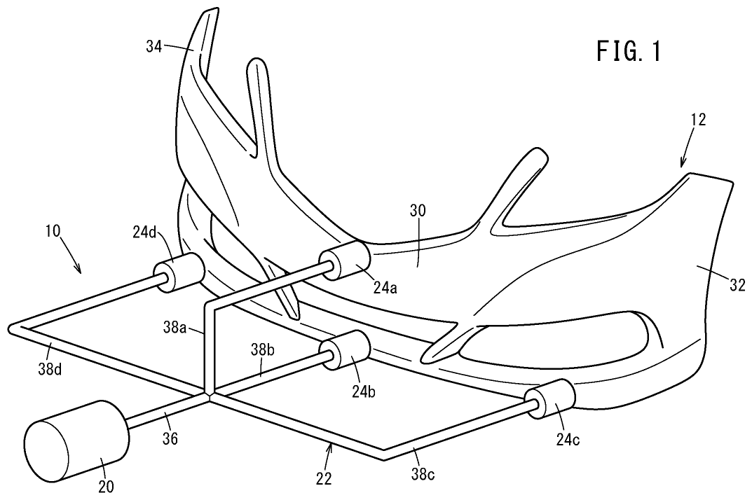

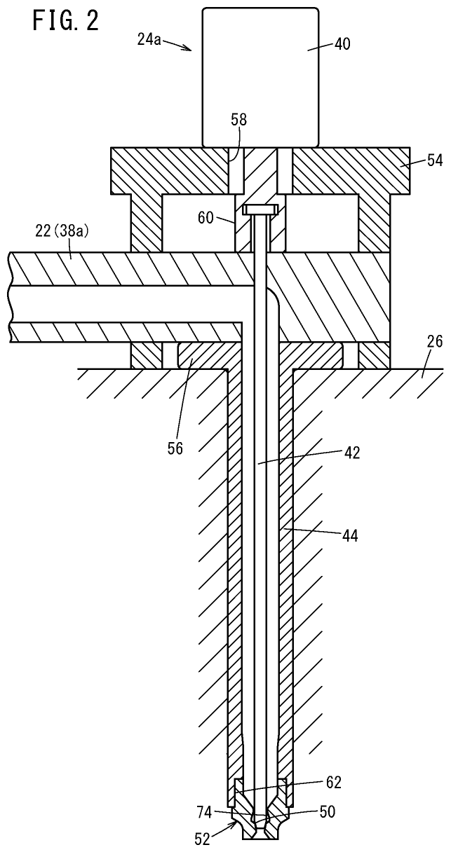

FIG. 1 is a principal parts outline perspective schematic view schematically showing principal parts of an injection molding device 10 according to the present embodiment, and a front bumper 12 (a resin molded article) obtained by the injection molding device 10. This injection molding device 10 comprises: a supplying machine 20 that supplies a molten resin; a hot runner block 22 as a distributor that distributes the molten resin that has been supplied from the supplying machine 20; and first through fourth injectors 24a-24d provided at downstream extremities of the hot runner block 22. The hot runner block 22 is supported by a fixed mold 26 shown in FIG. 2, via the first through fourth injectors 24a-24d.

The injection molding device 10 further includes: the fixed mold 26; and a movable mold (not illustrated) which is displaceable in a direction of approaching or separating from the fixed mold 26. A cavity for obtaining the front bumper 12 is formed by the fixed mold 26 and the movable mold. Note that the front bumper 12 is exterior equipment of an automobile vehicle body.

The front bumper 12 includes a center section 30, a left side section 32 running around to a leftward side from a vehicle body left end of the center section 30, and a right side section 34 running around to a rightward side from a vehicle body right end of the center section 30. On the other hand, the hot runner block 22 includes first through fourth branch passages 38a-38d that branch from a branching point of an aggregated passage 36, and, among these first through fourth branch passages 38a-38d, the first branch passage 38a and the second branch passage 38b respectively distribute the molten resin to an upper side and a lower side of the center section 30. Moreover, the third branch passage 38c and the fourth branch passage 38d respectively distribute the molten resin to a lower side of a front surface of the left side section 32 and a lower side of a front surface of the right side section 34. The second branch passage 38b extends so as to be coaxial with the aggregated passage 36.

Note that when volume of the upper side of the center section 30, volume of the lower side of the center section 30, volume of the left side section 32, and volume of the right side section 34 are assumed to be, respectively, Va, Vb, Vc, and Vd, there is a relationship of Va>Vc≈Vd>Vb. That is, in the upper side of the center section 30, the lower side of the center section 30, the left side section 32, and the right side section 34, volumes to be filled or volumes for which pressure keeping is to be performed differ, and resin amounts required in respective regions also differ.

The first through fourth injectors 24a-24d are respectively arranged at downstream side extremities of the first through fourth branch passages 38a-38d. That is, the first injector 24a and the second injector 24b respectively inject molten resin into the upper side of the center section 30 and the lower side of the center section 30, and the third injector 24c and the fourth injector 24d respectively inject molten resin into the lower side of the left side section 32 and the lower side of the right side section 34.

FIG. 2 is a principal parts outline cross-sectional view along a longitudinal direction of the first injector 24a provided at a downstream side extremity of the hot runner block 22. The first injector 24a includes: an electronically controlled actuator (hereafter, written simply as “actuator”) 40; a valve pin 42 as a valve body; a sleeve 44 configured from a hollow cylindrically shaped body; and a top nozzle 52 provided with a valve seat 50.

The first injector 24a further includes a base holder 54 for supporting the actuator 40 and holding the hot runner block 22 in the fixed mold 26. A downstream extremity of the hot runner block 22 is housed in the base holder 54, which is of hollow box type.

The sleeve 44 includes a flange section 56 which is sandwiched by the hot runner block 22 and the fixed mold 26. By this flange section 56 functioning as a spacer, a separation distance between the hot runner block 22 and the fixed mold 26 becomes substantially constant. Of course, a hollow inside (a runner) of the hot runner block 22 communicates with a hollow inside of the sleeve 44.

An insertion hole 58 is formed in an opposing wall of the base holder 54 that opposes the fixed mold 26. A drive rod 60 of the actuator 40 is passed through the insertion hole 58, and the valve pin 42 is held in the drive rod 60. The valve pin 42 is housed within the sleeve 44 as described above.

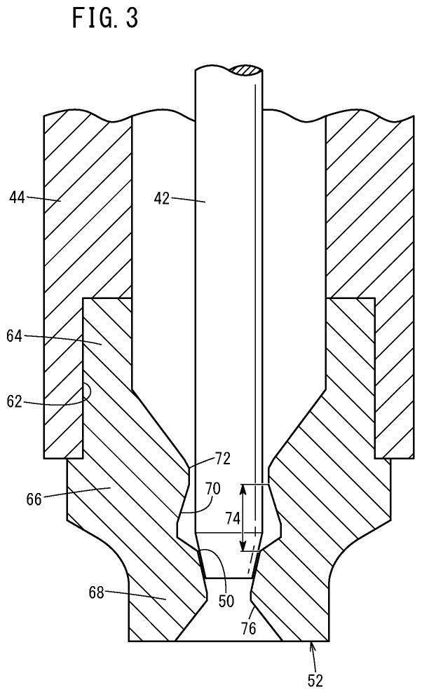

A fitting groove 62 is formed in a ring shape inside a tip of the sleeve 44. The top nozzle 52 is fitted in this fitting groove 62. Specifically, as shown in detail in FIG. 3, the top nozzle 52 includes: a cylindrical end section 64; a flange-shaped stopper section 66; and an injection side end section 68 whose outer diameter is smaller than those of the cylindrical end section 64 and the stopper section 66, is reduced in a tapered shape with decreasing distance to the cavity, and then becomes uniform. Among these sections, the cylindrical end section 64 is fitted in the fitting groove 62. At this time, the stopper section 66 abuts on the tip of the sleeve 44, whereby further insertion of the top nozzle 52 is stopped.

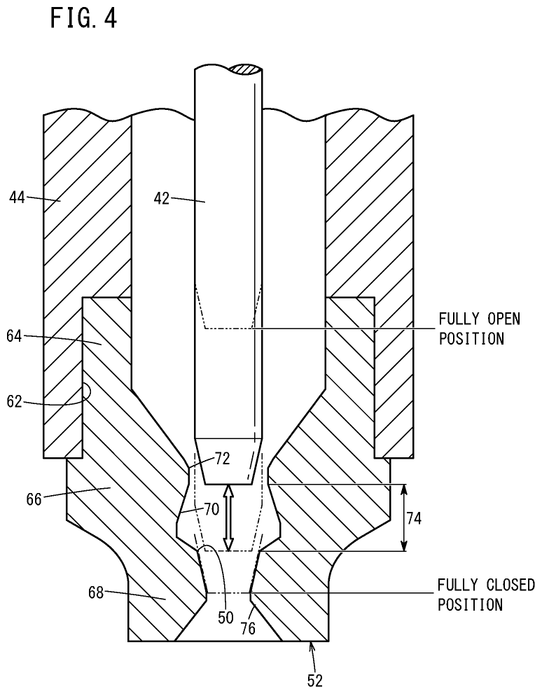

The top nozzle 52 has formed therein a resin flow passage 70 along which molten resin that has flowed in from the hollow inside of the sleeve 44 flows. The resin flow passage 70 is configured to have substantially the same diameter as a diameter of the hollow inside of the sleeve 44 on an upstream side within the cylindrical end section 64, and has a diameter that is reduced in a tapered shape with decreasing distance to the stopper section 66. That is, a constriction 72 is formed in a vicinity of the stopper section 66. When the first injector 24a is set fully open, the valve pin 42 is retracted further to an upstream side than the constriction 72 as shown in FIG. 4. In other words, the valve pin 42 is in a fully open position when it has retracted further to an upstream side than the constriction 72.

A cross-sectional area varying section 74 whose cross-sectional area in a direction orthogonal to a flow direction increases, is provided on a downstream side of the constriction 72, that is, within the stopper section 66. The resin flow passage 70 is formed including this cross-sectional area varying section 74. In the present embodiment, the cross-sectional area varying section 74 is defined by a diameter of the resin flow passage 70 expanding in a tapered shape as the resin flow passage 70 approaches the injection side end section 68. Therefore, the cross-sectional area varying section 74 has a cross-sectional area that becomes larger with decreasing distance to the injection side end section 68. Hence, a cross-sectional area of a ring-shaped passage formed by the cross-sectional area varying section 74 and the valve pin 42 that has entered the cross-sectional area varying section 74, becomes gradually larger with decreasing distance to the injection side end section 68.

The cross-sectional area of the cross-sectional area varying section 74 is maximum in a vicinity of a boundary of the stopper section 66 and the injection side end section 68, and the valve seat 50 is formed on a downstream side thereof. The resin flow passage 70 is blocked by the valve pin 42 advancing to be seated on the valve seat 50. That is, the first injector 24a is set to a fully closed state. Thus, the valve pin 42 attains a fully closed position by being seated on the valve seat 50.

An injection port 76 is formed in the injection side end section 68, on a downstream side of the valve seat 50. An upstream side of the injection port 76 has a diameter that is reduced in a tapered shape, while its downstream side has a diameter that expands in a tapered shape.

The valve pin 42 advances toward the valve seat 50 side due to the drive rod 60 of the actuator 40 being fed out, and attains the fully closed position. On the other hand, the valve pin 42 retracts in a direction of separating from the valve seat 50 due to the drive rod 60 being drawn in, and attains the fully open position. The actuator 40 is capable of stopping the drive rod 60 in mid-course of this advancement or retraction, as shown by the imaginary lines in FIG. 4. The valve pin 42 also stops with stopping of the drive rod 60. Therefore, the valve pin 42 can be stopped at any position between the fully closed position and the fully open position, that is, at a predetermined intermediate position.

Typically, the predetermined intermediate position is within a range from the valve seat 50 to the constriction 72. That is, the predetermined intermediate position is set within a range of the cross-sectional area varying section 74.

The remaining second through fourth injectors 24b-24d are configured in conformity to the first injector 24a. Hence, the same configuring elements will be assigned with the same reference symbols, and detailed descriptions thereof will be omitted.

The injection molding device 10 according to the present embodiment is basically configured as above, and the operational advantages thereof will next described in relation to an injection molding method according to the present embodiment. Note that operation below is implemented under controlling action of an unillustrated control section.

In order to form the front bumper 12, first, a cavity is formed by bringing the movable mold close to the fixed mold 26. The hollow inside (the runner) of the hot runner block 22 communicates, via the first through fourth injectors 24a-24d, with the cavity. At this time point, the valve pins 42 of the first through fourth injectors 24a-24d are seated on the valve seats 50. That is, all valve pins 42 are in the fully closed position (refer to FIG. 3).

Next, a filling step in which the cavity is filled with molten resin, is performed. That is, the supplying machine 20 is energized, and the actuators 40 configuring the first through fourth injectors 24a-24d are also energized. By the supplying machine 20 being energized, molten resin is delivered to the aggregated passage 36 of the hot runner block 22 from the supplying machine 20. The molten resin is further distributed to each of the first through fourth branch passages 38a-38d.

Moreover, by the actuators 40 being energized, the drive rod 60 of each of the first through fourth injectors 24a-24d retracts, and the valve pin 42 retracts integrally with the drive rod 60. As a result, the valve pin 42 separates from the valve seat 50, and the first through fourth injectors 24a-24d are set to an open state. At this time, all valve pins 42 are set to the fully open position shown in FIG. 4.

Due to the first through fourth injectors 24a-24d being opened in this way, the molten resin that has been delivered to the first through fourth branch passages 38a-38d passes through the hollow inside of the hot runner block 22, the hollow inside of the sleeve 44, and the resin flow passage 70 inside the top nozzle 52 to be introduced into the cavity from the injection port 76 of the top nozzle 52. As a result, filling of the cavity with molten resin is started.

Now, as described above, the volumes of the upper and lower sides of the center section 30, the left side section 32, and the right side section 34, differ from each other, so required resin amounts (volumes) differ. Hence, there is concern that, if injection speeds or injection pressures of the molten resin from the first through fourth injectors 24a-24d are all set the same, then, in the case of the cavity being large-sized, a hollow will occur when overall injection pressure is excessively small. On the other hand, when overall injection pressure is excessively large, mold-floating will occur, whereby a burr is generated.

Furthermore, if injection speeds or injection pressures of the molten resin from the first through fourth injectors 24a-24d are the same, then filling of the lower side of the center section 30 will be completed first. In this case, the molten resin with which the lower side of the center section 30 has been filled will begin to solidify, so its cooling start timing will be earlier compared to that of molten resin supplied to other regions. There is concern that, if there is a marked difference in cooling start timings, then a hollow will occur.

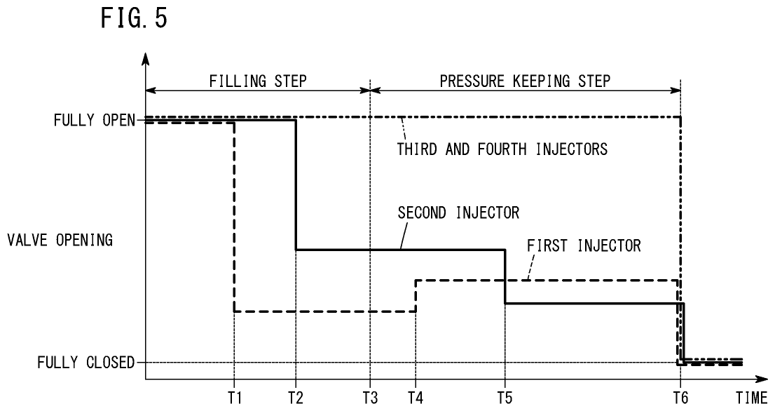

In order to avoid this, in mid-course of filling, that is, after a predetermined time T1 has elapsed from starting the filling step, the valve pin 42 of a predetermined injector is moved to within the range of the cross-sectional area varying section 74 (the predetermined intermediate position) under controlling action of the actuator 40, and injection speed or injection pressure is reduced. As shown in FIG. 5, in the present embodiment, the valve pins 42 of the first and second injectors 24a, 24b are displaced. Note that in FIG. 5, the position of the valve pin 42 is expressed as “valve opening”, and a more upward location on the y axis signifies a greater amount of valve opening.

In this case, first, the valve pin 42 of the first injector 24a is displaced to the injection side end section 68 side where the cross-sectional area is comparatively large, of the cross-sectional area varying section 74. Injection speed, which is sufficiently small while the valve pin 42 moves from the fully open position to the position indicated by the solid line in FIG. 4, becomes even smaller when the valve pin 42 is positioned on the injection side end section 68 side. At a place where the cross-sectional area is large, amount of change of the injection speed is small with respect to amount of movement of the valve pin 42. Hence, an optimal place for flow speed adjustment amount is preferably set on the injection side end section 68 side where the cross-sectional area is large. This is because flow speed of molten resin can thus be easily adjusted by adjusting the position of the valve pin 42.

Then, when a predetermined time has further elapsed from T1, and cumulative time after starting the filling step has reached T2, the valve pin 42 of the second injector 24b is positioned on the stopper section 66 side where the cross-sectional area is comparatively small, of the cross-sectional area varying section 74. In this case, since the cross-sectional area of the ring-shaped passage is small, the injection speed of the molten resin becomes larger than that in the first injector 24a.

By appropriately adjusting injection speeds or injection pressures of molten resin in this way, injection completion timings of molten resin from the first through fourth injectors 24a-24d can be made to be substantially the same. Therefore, cooling start timings of the molten resin that has been injected into the cavity from the injectors (24a-24d) match, and resin pressure within the cavity differs for each region.

After a time T3 has elapsed from start of the filling step and filling has been completed, a pressure keeping step is performed. That is, openings of the valve pins 42 of the first through fourth injectors 24a-24d are kept at the openings at the time of filling step completion until a predetermined time elapses. As a result, pressure from the molten resin within the top nozzle 52 acts on the molten resin within the cavity.

In a vicinity of a region including a boss, rib or the like, of the front bumper 12, a contraction amount when the molten resin is solidified is large. In contrast, in a region not including a boss, rib or the like, the contraction amount is comparatively small. Hence, there is concern that, if pressures of pressure keeping due to the first through fourth injectors 24a-24d are set equal, then a hollow will occur in the region where contraction amount is large.

Accordingly, in the present embodiment, after a predetermined time has elapsed from filling being completed (from pressure keeping being started), that is, after a time T4 has elapsed from start of the filling step, first, the valve pin 42 of the first injector 24a is displaced to the stopper section 66 side where the cross-sectional area is comparatively small, of the cross-sectional area varying section 74. Speed or pressure of the injection from the first injector 24a thereby increases, and, as a result, pressure imparted on the molten resin within the cavity becomes larger.

Moreover, after a predetermined time has elapsed from the opening of the valve pin 42 of the first injector 24a being changed as described above (after a time T5 has elapsed from start of the filling step), the valve pin 42 of the second injector 24b is displaced to the injection side end section 68 side where the cross-sectional area is comparatively large, of the cross-sectional area varying section 74. As a result, speed or pressure of the injection from the second injector 24b slightly decreases, and pressure imparted on the molten resin within the cavity becomes slightly smaller.

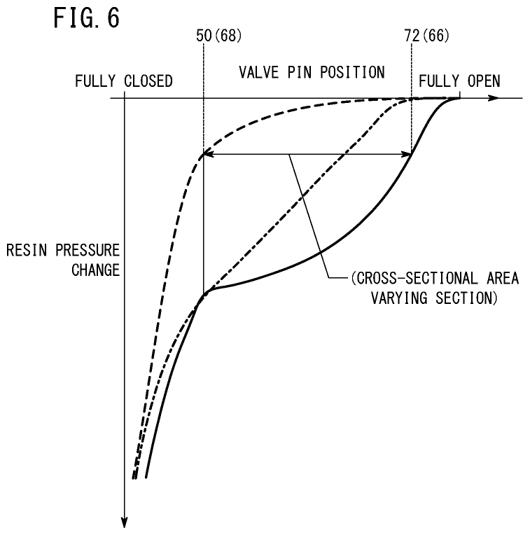

Now, in FIG. 6, a relationship of position of the valve pin 42 and pressure of injected molten resin (resin pressure) in the case of employing the top nozzle 52 in which the cross-sectional area varying section 74 is provided in the resin flow passage 70 is shown as a solid line, and a relationship of position of the valve pin 42 and resin pressure in the case of employing a top nozzle according to conventional technology whose inner diameter is uniform and which is not provided with the cross-sectional area varying section 74 is shown as a broken line. It may be understood from this FIG. 6 that when the cross-sectional area varying section 74 is provided, and a position of the tip of the valve pin 42 is varied within the range of the cross-sectional area varying section 74, the resin pressure varies gently. The reason for this is because variation in cross-sectional area of the ring-shaped passage becomes gentle.

Thus, by providing the cross-sectional area varying section 74 in the resin flow passage 70 inside the top nozzle 52, the injection speed or injection pressure of the molten resin, and the pressure imparted on the molten resin within the cavity can be precisely changed. That is, by employing the top nozzle 52, it becomes possible for the injection speed or injection pressure of the molten resin, and, furthermore, the pressure imparted on the molten resin within the cavity, to be adjusted to a desired degree.

Moreover, the resin pressure within the cavity can be made different according to region; for example, a region where high pressure is required is set to a high pressure, and a region where low pressure suffices is set to a low pressure. Therefore, it is avoided that resin pressure becomes excessively large over the whole of the cavity. It is therefore suppressed that mold-floating occurs and a burr is thereby generated. Contrarily, it is also avoided that resin pressure becomes excessively small over the whole of the cavity. It is therefore also suppressed that a resin filling amount within the cavity becomes deficient and a hollow occurs.

After a predetermined time T6 has elapsed from starting the filling step, all of the first through fourth injectors 24a-24d are set to the fully closed state, thereby completing the pressure keeping step. In this state, the molten resin is cooled and solidified inside the cavity, and the front bumper 12 as the resin molded article is thereby obtained. After mold-opening in which the movable mold separates from the fixed mold 26 has been performed, the front bumper 12 is pressed by, for example, an unillustrated ejector pin, and released from the fixed mold 26. The front bumper 12 excels in aesthetic appearance with suppressed burrs or hollows.

The present invention is not specifically limited to the above-described embodiment, and may undergo a variety of alterations in a range not departing from the spirit of the present invention.

For example, although in the present embodiment, change in openings of the valve pins 42 of the third and fourth injectors 24c, 24d is not specifically performed, there may of course be adopted a configuration whereby their openings are changed as required.

Moreover, the resin molded article may be other than the front bumper 12. Furthermore, the number of injectors, injectors to have their openings changed, the opening change timings, and so on, are not specifically limited to those of the example shown in FIG. 5, and may be variously set.

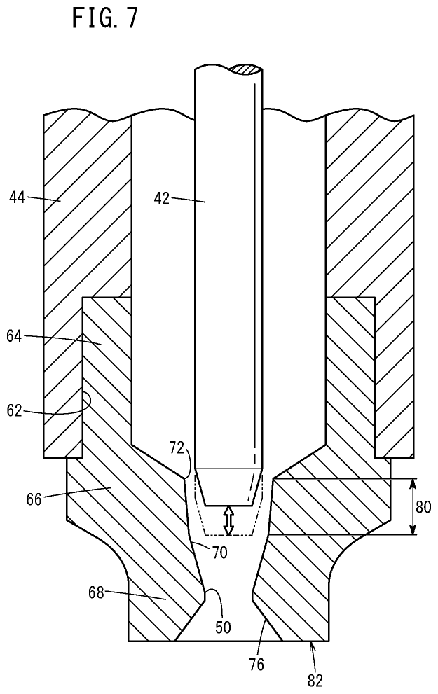

Furthermore, as shown in FIG. 7, a top nozzle 82, which is provided with a cross-sectional area varying section 80 whose diameter is reduced in a tapered shape from the stopper section 66 toward the injection side end section 68, may be employed. Change in resin pressure at this time is additionally shown as the one dot-chain line in FIG. 6.

As may be understood from this FIG. 6, in the top nozzle 82, a range in which resin pressure can be reduced is widened. Hence, it is easy for resin pressure to be varied, providing excellent versatility.

Moreover, although the injection molding device 10 has a configuration enabling intermediate positions of the valve pins 42 of the first through fourth injectors 24a-24d to be made different, there may be adopted a configuration such that in the case where, even if the intermediate positions are not made different, hardly any burrs or hollows are formed in the resin molded article (the front bumper 12, or the like), injection is performed with the intermediate positions of the valve pins 42 in all of the injectors (24a-24b) matched.

### REFERENCE SIGNS LIST

10: injection molding device
12: front bumper
20: supplying machine
22: hot runner block
24a to 24d: injectors
26: fixed mold
40: electronically controlled actuator
42: valve pin
50: valve seat
52, 82: top nozzle
60: drive rod
64: cylindrical end section
66: stopper section
68: injection side end section
70: resin flow passage
72: constriction
74, 80: cross-sectional area varying section
76: injection port

What is claim is:

1. An injection molding method for obtaining a molded article by injecting molten resin into a cavity of an injection molding device from a plurality of injectors, the injection molding method comprising:
a filling step in which a valve body provided within each of the injectors and configured to open or close an injection port of the injector is separated from a valve seat to set the injection port to an open state, and the cavity is filled with molten resin; and
a pressure keeping step in which the valve body is moved to a predetermined intermediate position between a fully closed position and a fully open position, and the molten resin within the cavity is pressurized,
the predetermined intermediate position being made different in at least two of the injectors.

2. The injection molding method according to claim 1, wherein, in the filling step, the valve body is set to a predetermined intermediate position between the fully closed position and the fully open position, and the predetermined intermediate position is made different in at least two of the injectors.

3. The injection molding method according to claim 1, wherein, at the predetermined intermediate position, a cross-sectional area in a direction orthogonal to a flow direction, of a resin flow passage along which the molten resin flows varies with decreasing or increasing distance from the valve body.

4. An injection molding device that obtains a molded article by injecting molten resin into a cavity from a plurality of injectors,
the injector including: a nozzle provided with a valve seat; a valve body that is seated on or separated from the valve seat; and a displacement unit configured to displace the valve body in a direction of approaching or separating from the valve seat,
a resin flow passage along which the molten resin flows being formed inside the nozzle,
the resin flow passage including a cross-sectional area varying section whose cross-sectional area in a direction orthogonal to a flow direction varies with decreasing or increasing distance from the valve body, and
the displacement unit being configured to stop the valve body at any position in the cross-sectional area varying section.

5. The injection molding device according to claim 4, wherein the cross-sectional area of the cross-sectional area varying section becomes larger with decreasing distance to the valve seat.

6. The injection molding device according to claim 4, wherein the cross-sectional area of the cross-sectional area varying section becomes smaller with decreasing distance to the valve seat.
